(19) United States
(12) Patent Application Publication
(10) Pub. No.: US 2003/0198534 A1
(43) Pub. Date: Oct. 23, 2003

(54) Device for automatically binding booklets of variable thickness, comprising at least two feed means

(75) Inventor: Francesco Valentinis, Torino (IT)

Correspondence Address: YOUNG & THOMPSON, 745 SOUTH 23RD STREET 2ND FLOOR, ARLINGTON, VA, 22202

(73) Assignee: CEM S.P.A., Milano (IT)

(21) Appl. No.: 10/397,357

(22) Filed: Mar. 27, 2003

(30) Foreign Application Priority Data
Apr. 19, 2002 (IT) MI2002 A 000841

(51) Int. Cl. B42C 1/00

(52) U.S. Cl. 412/9

(57) ABSTRACT

A device for automatically binding booklets (5) each presenting a variable number of sheets (4), comprising assembler means (40) for grouping the sheets of each booklet and presenting at least two separate means (80, 81) for feeding the sheets of each booklet towards a common gathering station (82), means (89, 41) for moving each booklet from said station to said binding means (33), and means (3) for measuring the thickness of each booklet (5) to be automatically bound, the binding means (33) forming for each booklet, on the basis of the measured thickness of the booklet to be bound, a personalized covering element for at least part of the visible faces and for an outer edge of the booklet.

The present invention relates to a device for automatically binding booklets comprising a variable number of sheets and hence of different thicknesses.

In the present context the term “sheets” means flexible elements of any material and thickness, while “booklet” means an assembly of sheets all of the same type or of different types, or an assembly in which only the first or the last sheet of the booklet are of different type, to act for example as a front cover and/or back cover. Consequently, in the present context, the first sheet of the booklet is either a booklet front cover or, depending on the particular case, the first actual sheet of the booklet (in the case of booklets without a front cover); the term “binding” means that operation by which the sheets of a booklet are joined together by gluing and/or stapling along one of their edges, a covering element then being made to cover and bind to said edge and to at least one portion of the first and last sheet of the booklet along said edge, said covering element being suitably folded such that its parts adhere perfectly to said edge and said portions.

Adhesive-binding devices are known, however such devices are able to apply a binding element automatically only to booklets having all the same thickness.

The known binding methods and devices do not enable booklets to be bound comprising sheets and in particular single pages having characteristics (for example paper colours) and/or print types (in black/white or in colour) which are different and in which said different sheets can be combined in any order within the booklet and are fed one at a time, in a desired sequence, to a station in which the sheets of each booklet are gathered and the booklet is formed, starting from at least two different feed means.

An object of the present invention is to provide a device able to automatically bind booklets having any desired thickness or a variable number of sheets in which the individual sheets which comprise the booklet can have characteristics and/or print types which differ and vary in any manner from sheet to sheet and are fed one at a time, in a desired sequence by separate feed means, to a station in which the sheets of the booklet are gathered together and the booklet is formed.

A further object is to provide a device of simple type and easy assembly.

These and further objects which will be apparent to an expert of the art are attained by a device in accordance with the characterising part of the main claim.

The present invention will be better understood from the accompanying drawings, which are provided by way of non-limiting example and in which:

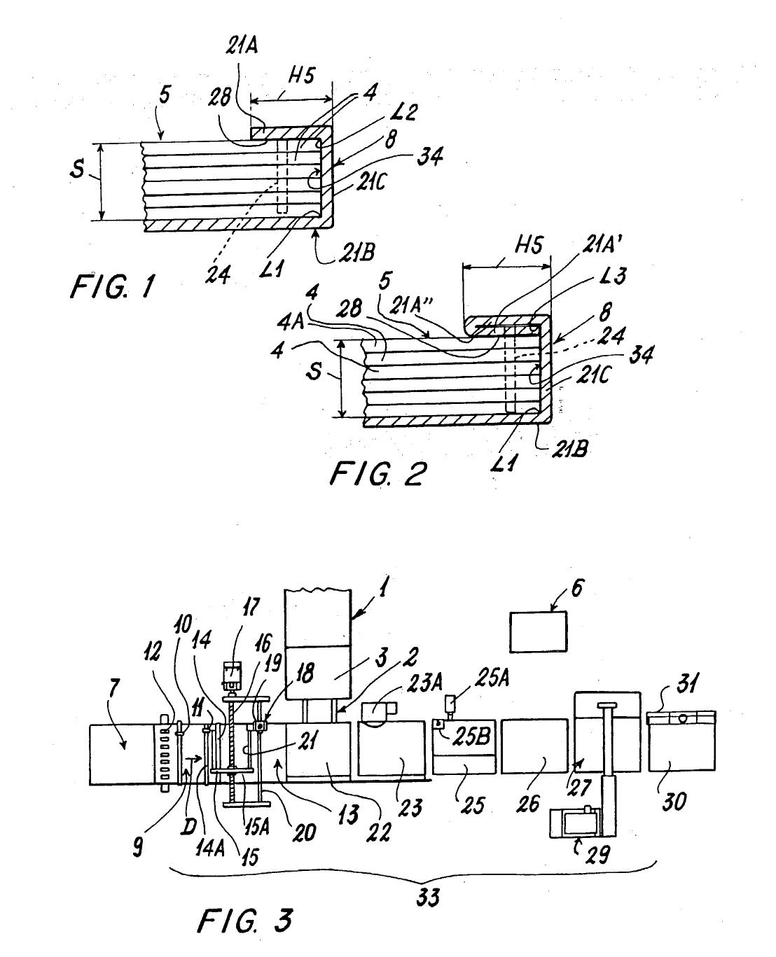

FIGS. 1 and 2 are a schematic cross-section through a booklet bound in two different ways by a device according to the invention;

FIG. 3 is a schematic view from above of a device according to the invention;

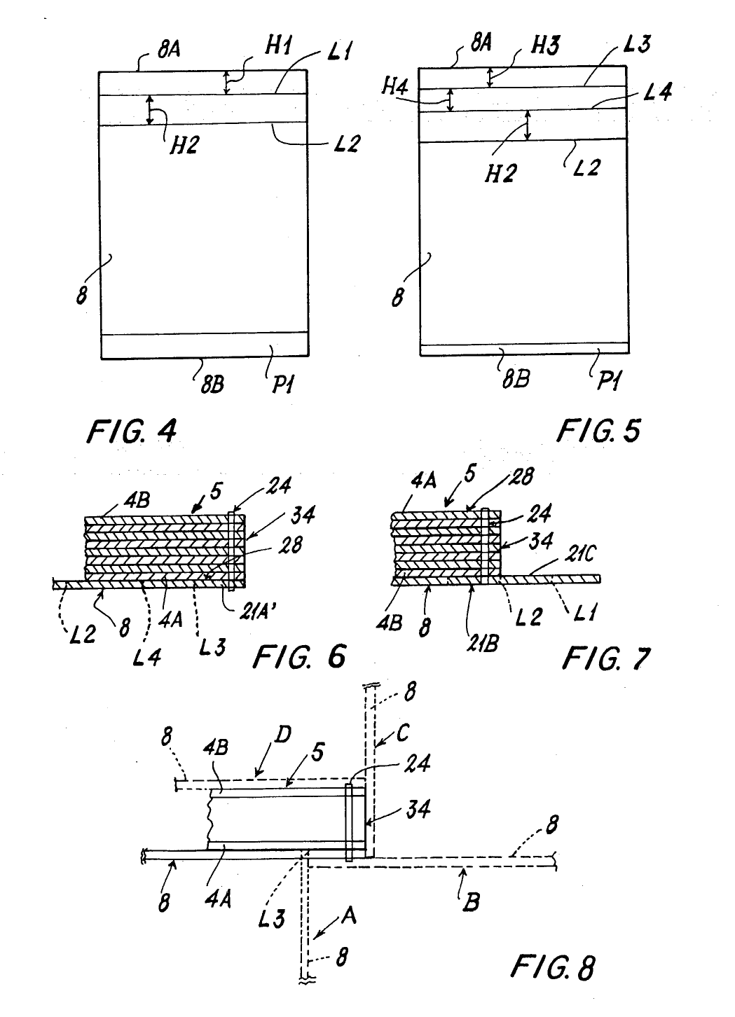

FIGS. 4 and 5 show two different back covers in an intermediate stage of their processing;

FIGS. 6, 7, 8 are a cross-section through the booklet and relative binding element in an intermediate stage of their processing;

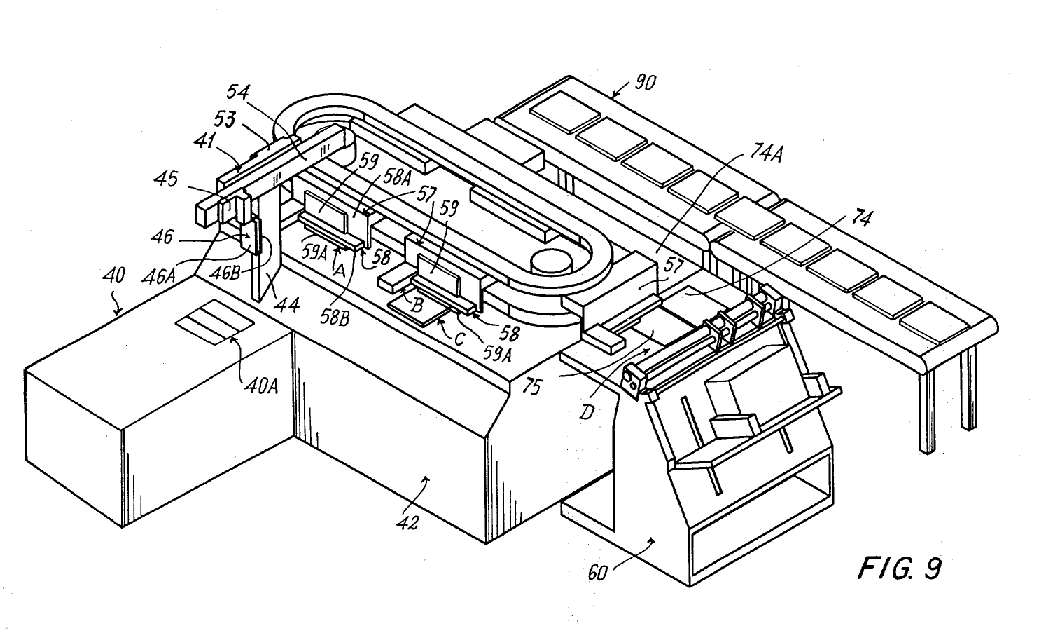

FIG. 9 is a schematic perspective view of a second embodiment of the device;

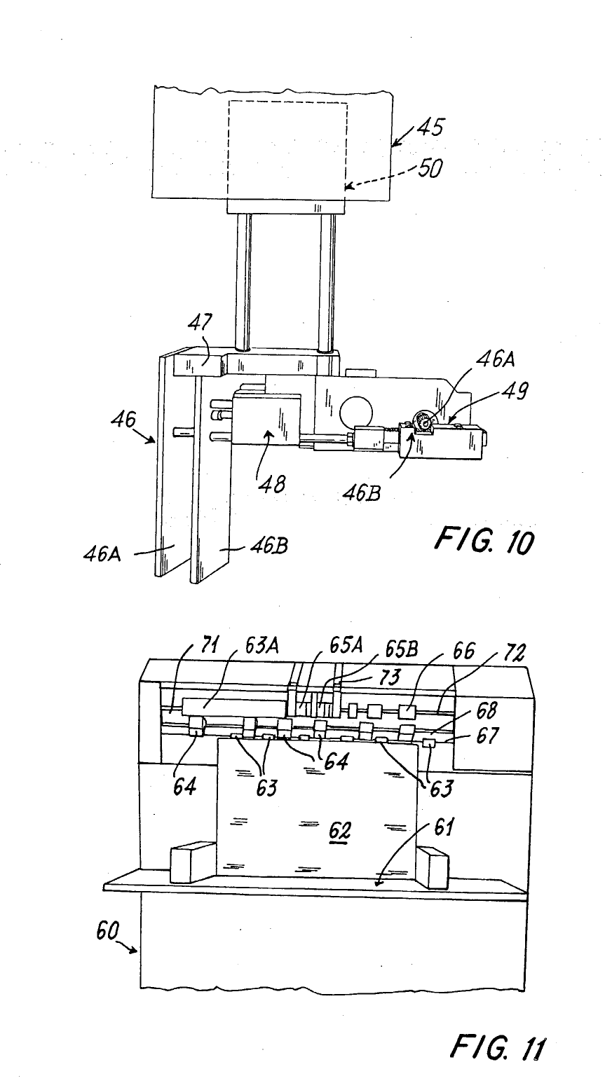

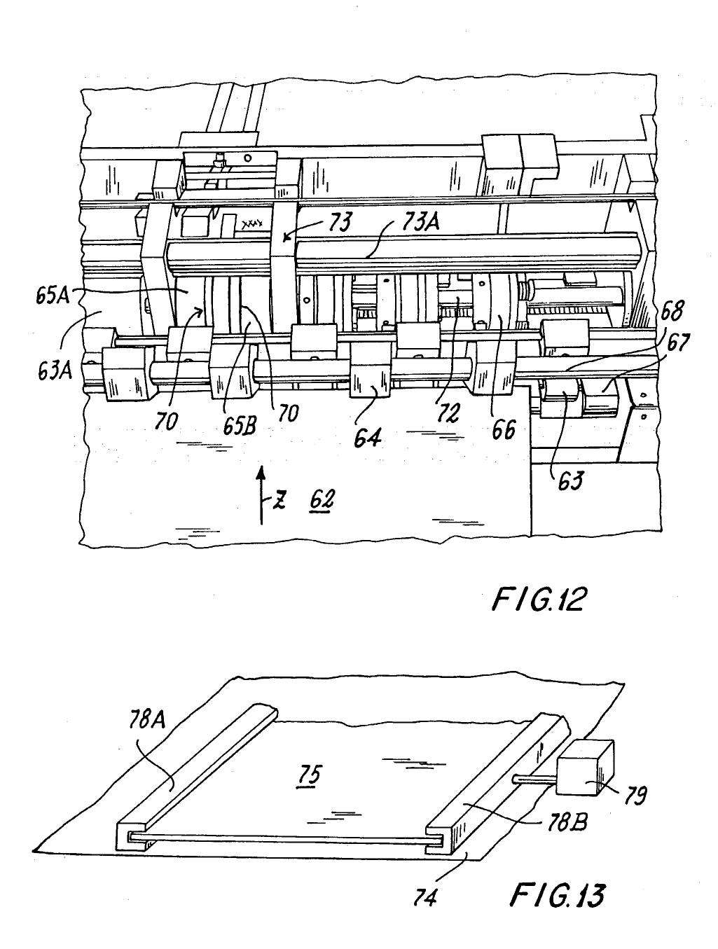

FIGS. 10, 11, 12, 13 are schematic perspective views of certain details thereof;

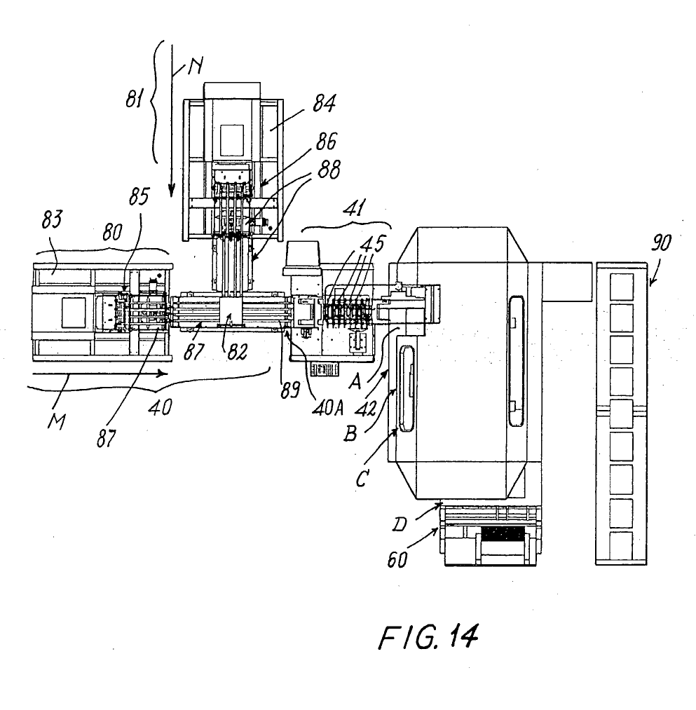

FIG. 14 is a schematic perspective view of a variant of the embodiment of FIG. 9.

With reference to FIG. 3, this shows a device according to the invention, comprising a usual device 1 for grouping an assembly of sheets 4 pertaining to the same booklet 5, and usual conveyor means 2 for conveying towards a binding line 33 the various booklets generated by the device 1. This latter is of usual type and comprises usual means 3 for measuring the thickness S (FIGS. 1, 2) of each booklet 5 to be bound. If the sheets of the booklets 5 are all of the same type, the thickness measurement means could comprise a usual member able to count the sheets while they are being grouped one on another to form the booklet; this member can be of mechanical or electronic type and comprise for example a photoelectric cell. The information obtained relative to the number of sheets of the booklet is then fed to a control and processing unit 6 of the binding line which, by means of algorithms of conventional type, calculates the booklet thickness. This thickness can also be calculated by other conventional measurement means able to automatically determine the dimensions of an article and to feed a relative electrical signal to the control unit 6.

The binding line 33 comprises a first station 7 acting as a reservoir for the binding elements 8, hereinafter also known as back covers or covering elements. This station comprises a usual holder in which the back covers are piled one on another, and means for transferring the back covers of the first station 7 one at a time to a creasing station 9.

The back covers 8 are formed from a sheet preferably of a paper or plastic material, or in any event a material which can be folded and which once folded maintains the fold. These back covers could for example be made of lightweight cardboard.

The creasing station 9 comprises one or two fixed creasing elements 10, a movable creasing element 11 and usual means 12 for transferring the back covers from the creasing station 9 to a trimming station 13. Only one fixed disc is shown in the figures; one or two fixed discs are required, depending on the type of binding to be effected, as will be explained hereinafter. The creasing elements 10 and 11 comprise a metal or hard plastic disc shaped such that its edge forms a groove or a weakening line in the back cover, to facilitate and regulate its subsequent folding. Each of the creasing discs advantageously comprises an underlying backing disc; the back cover passes between the creasing disc and the backing disc. The movable creasing element 11 and the relative disc are movable along a guide element 14A and are rigidly secured to an arm 14 connected to a carriage 15 movable perpendicular to the direction D of advancement of the back cover. The carriage 15 is connected to a guide element 16 and to usual means 17 for its movement. In this manner, the movable creasing element 11 can be moved automatically, perpendicular to the direction of advancement D of the back covers, into any desired position.

The first creasing element 10 is arranged to form in the back cover 8 a first folding line L1 (FIG. 4) in a predefined position, namely in proximity to an edge 8A of the back cover, at a predefined distance H1 from said edge. This distance H1 is equal to the distance H5 (FIG. 1) of that part 21A of the back cover located on the first page of the booklet. The part 21A always has the same width H5 for all the booklets, whatever their thickness. The movable creasing element 11 is arranged to form in the back cover 8 a second folding line L2, parallel to the first line L1, at a distance H2 from this latter equal to or slightly greater than the thickness S of the booklet to be bound.

If the upper part of the binding element is to be folded back on itself to achieve the “back-folded” binding shown in FIG. 2, a first fixed creasing element 10 forms a first creasing line L3 at a distance H3 from the edge 8A which is slightly less than the width H5 (FIG. 2) of the visible part 21A of the covering element, and a second fixed creasing element (not shown) forms a second creasing line L4 at a distance H4 from the first line L3 equal to the width H5 (FIG. 2) of the visible part 21A of the covering element; finally the movable creasing element 11 forms a third creasing line L2 at a distance H2 from the second line L4 equal to the sum of the thickness S of the booklet to be bound and the thickness S′ of the back cover.

The drive means 17 for the carriage 15 to which the movable creasing element 11 is connected are controlled by the control unit 6 such that this creasing element is always positioned in the correct positions based on the thicknesses S of the booklets 5 to be bound, i.e. positioned in such a manner as to impress the weakening lines L2 into the back covers 8 in such positions that when the back cover 8 is folded onto the edge 34 of the booklet, as shown in FIGS. 1 and 2, the parts 21A, B, C of this back cover adhere perfectly to the booklet itself, i.e. they follow perfectly the edge of the booklet and those portions of the first and last sheet of the booklet on which the back cover rests.

The trimming station 13 comprises a cutting member 18, for example a rotary blade, movable perpendicular to the direction of advancement of the back covers. The cutting member 18 is secured to a support element 19 movable along a guide 20 secured to an arm 21 connected to a carriage 15A which is advantageously movable along the same guide 16 as the carriage connected to the movable creasing element 11, and is driven by the same means 17 which drive this creasing element 11.

The trimming station is arranged to remove any portions P1, P2 and P3 from the back cover along that edge 8B thereof distant from the edge 8A along which the weakening lines are provided. In this respect, if the thickness S of the booklet to be bound is less than the maximum thickness which can be bound with the back cover 8, a portion P1 must be removed from the edge 8B, and which would otherwise project from the booklet and require subsequent trimming operations.

The back cover 8 is conveyed by usual means from the trimming station 13 to a feed station 22 for the booklet to be bound. In this station the control unit 6, having verified by usual sensors, not shown, the presence of a back cover, moves onto this latter by the action of the means 2 the booklet having that thickness on the basis of which, in the preceding stations, the weakening lines L1-4 were incised in that back cover and the portions P1 were removed. The back cover and the relative booklet then pass together to a stapling station 23 comprising a conventional perforating member 23A; the back cover is secured to the booklet by making one or more staples 24 penetrate the booklet and the lower part 21B of the back cover, as shown in FIGS. 6 and 7. It should be noted that the booklet 5 and the back cover 8 are superposed and fed to the stapling station differently, depending on the type of binding to be obtained.

In the case of the “back-folded” binding of FIG. 2, the back cover 8 is associated with the booklet as shown in FIG. 6, with an edge 28 flush with the edge 34 of the booklet to be bound and with the booklet inverted, i.e. with its last page 4B in the upper position. In this condition, the booklet and back cover are stapled together by the staple 24. In the case of the “single” binding of FIG. 1, the back cover 8 is associated with the booklet as shown in FIG. 7 with its first page 4A in the upper position, and with the parts 21C, 21A of the back cover projecting beyond the edge 34 of the booklet to be bound. It should be noted that in the case of “single” binding, stapling is an optional operation. The booklet could be associated with the back cover with the sheets already stapled together, but without the staple 24 also securing the back cover (as shown in FIG. 1). The booklet and the back cover are then fed to a gluing station 25 comprising two glue expulsion members 25A, B, for example usual hot glue extruders, positioned such as to be able to spread the layer of glue onto the booklet and/or onto the back cover. In the case of the “back-folded” binding of FIG. 2, the glue is spread on the edge 34 of the booklet (FIG. 6), on a portion 28 of the last sheet 4B of the booklet in proximity to the edge 34, and on the visible face of the part 21A′ of the back cover. In contrast, in the case of “single” binding the glue is spread only on the edge 34 of the booklet and on that portion 28 of the first sheet 4A of the booklet 5 on which the part 21A of the back cover 8 is to adhere. It should be noted that in the case of single binding in which the booklet 5 and the back cover are not stapled together, but only the booklet is stapled, prior to the station 22 in which the booklet and back cover are associated there is provided an additional gluing station (not shown) arranged to spread a layer of glue on that face of the part 21B (FIG. 7) of the back cover 8 which is to come into contact with the last sheet 4B of the booklet. The combined back cover and binding element are then moved by usual conveying means (not shown) to a feed station 26 for a possible front cover for the booklet. This station is an accessory, the booklet being able either to comprise or not comprise a front cover. This station comprises a usual holder for containing the front covers and conventional means for moving the front covers one at a time onto the relative booklet.

A station 27 for rotating the parts 21A, B, C of the binding element 8 follows.

In the case of the single binding of FIG. 1, the operation of rotating the binding element is extremely simple, it being sufficient to make the parts 21C and 21A (FIG. 7) of this element adhere respectively to the edge 34 of the booklet and to the upper portion 28 of the first page, or of a possible front cover. In the case of the back-folded binding of FIG. 2, the back cover 8 is firstly detached from the first page 4A of the booklet. This can be done using sucker devices and/or wedge-shaped guides which are wedged between the first page 4A of the booklet and the back cover and which, by virtue of the weakening line L3, fold the back cover firstly perpendicular to the booklet, position A of FIG. 8, then parallel to the booklet and into contact with the part 21A′ of the back cover, position B. Then a first usual movable guide device, utilizing the weakening line L4, folds the back cover upwards making it adhere to the edge 34 (position C), and finally a second usual movable guide device, utilizing the weakening line L2, folds the back cover onto the booklet (position D).

Finally the binding line comprises a pressing station 30 for the back cover and in particular for those of its parts 21A, 21B, 21C which adhere to the nipped edge of the booklet.

This station comprises a usual flat press 31 arranged to compress at least a portion of the booklet in correspondence with the nipped edge.

FIG. 9 shows schematically a second embodiment of a possible binding device comprising: assembler means 40 (schematically represented in FIG. 9), arranged to assemble the booklets to be bound, and a member 41 for moving the booklets to be bound by the assembler means 40 to adhesive-binding means 42. Preferably the device of the present variant is arranged to bind booklets the sheets of which are not secured together by staples but by gluing one of the edges, in which the booklet covering element entirely covers the first and last sheet of the booklet and the glued edge, and is itself glued to said edge and to a portion of the first and last sheet in correspondence with said edge.

The assembler means 40 are of known type and will therefore not be described in detail hereinafter; they are arranged to automatically group the booklets to be bound and to move them one at a time to an exit station 40A with that edge of the booklet to be glued and bound facing downwards and the free edge facing upwards. The mover means 41 comprise an upright 44 secured in any known manner to the adhesive-binding means 42 or to the floor by its own independent pedestal (not shown), arranged to support a horizontal guide track 54 for one or more movable carriages 45, with which a movable gripping member 46 is associated. The movable gripping member 46 comprises a fixed vertical plate 46A and a plate 46B movable perpendicular to the former. More specifically, as shown in FIG. 10, the fixed plate 46A is rigidly secured to a flat support 47 carrying usual means 48 for horizontally moving the movable plate, for example a pneumatic piston, and usual means 49 for measuring the thickness of the booklet retained between the two plates 46A, B. The means 49 comprise, for example, a usual encoder arranged to sense the movement of a shaft 49A which, by means of a series of gearwheels, indicated overall by 49B, is rotated by the movement of the plate 46B. The measurement means 49 are connected by cables, not shown, to the device control unit, to provide this latter with a precise indication of the thickness of the booklet to be measured. To the movable carriage 45 there are connected conventional vertical mover means, for example a pair of pneumatic pistons, rigidly secured to the flat support 47. The carriage 45 is removably connected, in usual manner, to the horizontal guide track 54 with which there are also associated usual means 53 for automatically moving the carriage along the track. Usual sensors, not shown, are also provided to sense the movements and/or the attainment of end-of-travel points of the gripping member, and the presence of the booklets in the booklet withdrawal and discharge stations 40A, B respectively; these sensors and the mover means 53, 48, 50 are all controlled by the control unit of the entire device.

The gripping member 46 is arranged to lower the plates 46A, B, in the open position, as far as the exit station 40A of the assembler means, to grip between the plates 46A, B the booklet to be moved, to vertically raise the plates together with the booklet, to move them horizontally towards the adhesive-binding means 42, to lower them into an entry station A of the adhesive-binding means where the plates are opened to deposit the booklet to be bound, and to return to its initial position to withdraw the next booklet. The aforedescribed mover means are arranged to withdraw a booklet to be bound from the assembler means 40 one at a time, to transport it to the adhesive-binding means 42, and deposit each booklet onto a carriage 57 of the adhesive-binding means. Transport preferably takes place non-synchronously relative to the assembler means, it being possible to move a booklet only if a free carriage 57 is present in the entry station A of the adhesive-binding means.

The adhesive-binding means 42 comprise a plurality (only three are shown in FIG. 9) of carriages 57 movable automatically along an elliptical path to convey the booklets to be bound from one working station to the other. The carriages 57 conventionally comprise a support structure secured to drive means, for example of chain type, and to guide elements (not shown) with which there is associated a booklet gripping member 58 comprising a fixed vertical wall 58A and a bar 58B movable perpendicular to said fixed wall 58A. By virtue of the gripping member 58 the carriages 57 can move the booklets 59 from one working station to another with that 59A of their edges to be glued and bound facing downwards. The adhesive-binding means conventionally comprise an entry station A, a station B for cutting that edge 59A of the booklet to be bound, a station C for spreading a layer of glue onto said edge 59A and onto the sides of the booklet, a cover feeding station D, a station (not shown) for assembling the cover and the booklet together, and an exit station (not shown) connected to usual means 90 for moving the bound booklets.

Adhesive-binding means of the aforedescribed type are known and will therefore not be described in detail hereinafter.

Preferably the exit station 40A of the assembler means 40, the entry station A of the adhesive-binding means 42 and the means 41 for conveying the booklets between said two stations are disposed in series along a rectilinear path, the conveyor means being provided between said two stations.

At the cover feed station D, there are associated with the adhesive-binding means 42 means 60 for generating an appropriate cover for each booklet. These means 60 comprise a holder 61 for covers 62 to be cut to size, based on the thickness of each booklet, usual motorized rollers 63 and guide elements for moving one cover at a time from the holder to an exit station 64, and rotary members 65A and B, 66, arranged respectively to impress weakening lines into the cover and to trim the cover. The motorized rollers are connected in conventional manner to a common rotary shaft 67, whereas the guide elements 64 are connected to a crosspiece 68. The rotary member 65B and the cutting member 66 can not only rotate but also traverse perpendicular to the direction Z of advancement of the covers 62, whereas the other rotary member 65A is fixed with regard to these movements. The rotary members 65A, B comprise a first roller presenting a projecting circumferential portion 70 arranged to incise into the back cover a weakening and folding line. The cutting member 66 comprises a usual roller presenting a circumferential cutting portion and a rotary backing roller (not shown). That weakening member 65A which does not traverse axially is connected to a first rotary shaft 71, to which the roller 63A which moves the covers is also connected. The other weakening member 65B and the cutting member 66 are connected to a common rotary shaft 72 and to a support element 73 which can traverse along a horizontal guide 73A and is connected to mover means (not shown), for example to a pneumatic piston, arranged to simultaneously move the members 65B and 66 perpendicular to the direction of advancement Z of the covers into the appropriate position. The movements of the horizontal movable rotary weakening member 65B and of the cutting member 66 are controlled by the control unit of the device of the invention, in relation to the measured thickness of the booklet for which the cover being processed is intended. In this manner each booklet can be provided with a cover suitable for the booklet thickness.

Once formed, the finished cover 75 passes onto an exit surface 74 provided at a height less than that at which the booklets to be bound traverse, so that in this position the finished cover does not interfere with said booklets. The finished cover is moved by means of usual type (not shown) along a surface 74A as far as a station in which it is engaged with the booklet to be bound. Advantageously, in its passage towards the engagement station the cover is guided laterally by guide members comprising a fixed rail 78A and a rail 78B movable parallel to the first, both presenting along their opposing edges a central slot to house an edge of the cover. The movable rail 78B is connected to conventional mover means 79, for example pneumatic pistons, connected to and controlled by the device control unit, such that based on the dimensions of each cover the guide elements are always positioned at a suitable distance one from the other. The engagement station (not shown) is of known type, and comprises a first member for raising that portion of the cover lying between the two weakening lines, to cause that portion of the cover to adhere to the edge or rear of the booklet to be bound. This station also comprises a second plate member arranged to fold the cover and cause it to adhere to the first and last sheet of the booklet; this member preferably comprises a fixed plate disposed spaced from and perpendicular to the first raising member, and a second plate movable parallel to the first. The entry station A, the cutting station B, the gluing station C, the cover feed station D and the station in which the cover is engaged with the booklet have not been described in detail as they are of a type conventional in known adhesive-binding means; it should however be noted that the known devices are able only to form booklets all having the same thickness and equal cover dimensions.

It should also be noted that in addition to being measured by the measurement means 49 associated with the member 41 for moving the booklet from the assembler means 40 to the adhesive-binding means 42, the thickness of each booklet to be bound could be associated with other components of the device. The thickness of the booklet could be measured in the assembler means 40 by counting the number of sheets of each booklet and hence calculating from this information the thickness of the booklet in relation to the known thickness of the sheets.

Alternatively, the booklet thickness could be calculated by measuring the movement of the jaws of the gripping member provided in the carriages 57 of the adhesive-binding means.

It should be noted that, advantageously, the assembler means 40, the adhesive-binding means 42 and the booklet mover means 41 are distinct means separate from each other, and that the means for the non-synchronous movement of the booklets, with or without the booklet thickness measurement members, could also be used on booklet processing devices of conventional type, different from that hereinbefore described.

Using the device of the invention, booklets of different thicknesses can be automatically bound very rapidly and uniformly.

With reference to FIG. 14, this shows the assembler means 40 in detail, these comprising first and second means 80, 81 for feeding the sheets of each booklet, and a gathering station 82 for the sheets of each booklet. According to the invention the assembler means 40 therefore provide two distinct and separate feed streams of sheets for each booklet, namely a main stream M and a secondary stream N. The scope of the invention also includes the provision of more than two feed streams. The feed means 80, 81 comprise usual members 83, 84 for forming the individual pages of the booklets, usual members 85, 86 for identifying said individual pages on the basis of a code reproduced on said pages and read by said identification members, and usual members 87, 88 for moving said individual pages towards the gathering station 82 on the basis of the code read from the individual pages.

The members which form the individual pages comprise, for example, a printer and possibly a cutter if the individual pages of the booklet are formed starting from a continuous web. These members could however be replaced by usual members (not shown) able only to move the individual sheets and/or pages from preceding processing stations, and/or from printers located downstream of said members.

The members for identifying the individual sheets and/or pages comprise usual readers for a code reproduced on each page, for example a bar code. These readers are connected to a usual control unit which contains in its memory, or is able to calculate, the sequence of codes of the sheets of each booklet, and is also able to cause those sheets originating from the stream M to advance rather than those originating from the stream N only if the code read corresponds to that “expected”.

The members 87, 88 for moving the individual sheets and/or pages are of conventional type and comprise a plurality of conveyor belts and rollers or guides for maintaining said sheets in contact with the belts. Downstream of the booklet gathering station 82 there are provided usual booklet mover members 89 of the aforedescribed type.

By virtue of the multi-stream assembler means, booklets can be formed in which the individual pages can present characteristics different from the respective individual subsequent pages, for example one page can be printed in black and white by the means 83 and the next be printed in colour by the means 84, or the pages can be formed from coloured paper of different type.

In this manner booklets can for example be printed with pages in black and white and in colour quickly and economically. In contrast, using a single feed line the entire booklet, i.e. both the black and white pages and the colour pages, would have to be printed by a colour printer, with consequent high printing costs.

It should be noted that the order in which the individual sheets are fed to the booklet gathering station 82 from the two feed streams could be controlled by any conventional method different from the aforedescribed, and not based on codes reproduced on each page of the booklet.

Finally, it should be noted that the aforedescribed embodiments are provided by way of non-limiting example and that numerous modifications are possible all falling within the same inventive concept, for example with reference to the initially described embodiment, the binding line could comprise further stations to effect other different operations on the booklet, for example labelling or packaging (for example wrapping).

Moreover, again with reference to the initially described embodiment, instead of one fixed and one movable creasing element the creasing station could comprise a single movable creasing element or two or more creasing elements, both movable; the cover feed station could also be situated immediately downstream of the feed station for the booklet to be bound.

The binding element 8 could also comprise only those parts 21A, B, C which are in contact with the nipped edge of the booklet and with those portions of the first and last sheet immediately adjacent to said edge, or, in addition to a part acting as a back cover and extending over the entire last sheet of the booklet, also a part acting as a front cover and extending over the entire first page of the booklet.

1. A device for automatically binding booklets (5) each presenting a variable number of sheets (4), comprising assembler means (40) for grouping the sheets of each booklet, means (3) for measuring the thickness of each booklet (5) to be automatically bound, binding means (33) for forming for each booklet, on the basis of the measured thickness of the booklet to be bound, a personalized covering element for at least part of the visible faces and for an outer edge of the booklet; characterised in that the assembler means (40) present at least two separate means (80, 81) for feeding the sheets of each booklet towards a common gathering station (82), and means (89, 41) for moving each booklet from said station to said binding means (33).

2. A device as claimed in claim 1, characterised in that the assembler means (40) comprise members (88, 87) for moving the individual pages of each booklet towards said gathering station (82).

3. A device as claimed in claim 2, characterised in that the assembler means comprise members for reading an identification code present on each page of the booklet, means being provided for controlling the mover members (88, 87) in such a manner that said pages are moved towards the gathering station by one or the other of the feed means (80, 81) according to the code read.

4. A device as claimed in claim 1, characterised in that the sheets (4) of each booklet correspond to the individual pages of each booklet.

5. A device as claimed in claim 1, characterised in that the at least two feed means (80, 81) comprise members for moving at least two separate streams (M, N) of pages, said streams each originating from a separate printer for the pages of the booklet.

6. A device as claimed in claim 5, characterised in that at least one of the printers is for printing in colour and at least one other printer is for printing in black and white.

7. A device as claimed in claim 1, characterised by comprising a binding line (33) arranged to automatically fix, at least about that edge (34) of said booklet (5) in which the sheets are secured together and to a portion (28) of the first (4A) and last sheet of the booklet, a covering element (8) comprising a first part (21C) arranged to adhere to said edge (34), and a second (21A) and third part (21B) arranged to adhere respectively to at least said portions (28) of the first and last sheet; said line comprising means (9, 13) arranged to generate, on the basis of the measured thickness of the booklet to be bound, for each booklet, a particular personalized covering element (8) having dimensions and creasing lines (L1-L4) such that said three parts (21A-C) of the covering element perfectly follow said edge and said portions of the first and last sheet.

8. A device as claimed in claim 7, characterised in that the means arranged to generate for each booklet to be bound a particular covering element (8) comprise at least one creasing member (11) arranged to generate on each covering element a plurality of parallel weakening lines (L1-L4), two of said lines (L1-L2) being at a distance apart (H2) equal to or slightly greater than the thickness (S) measured for the booklet with which said covering element is to be associated.

9. A device as claimed in claim 8, characterised in that the creasing member (11) is arranged to generate two further creasing lines at a distance apart (H4) greater than or equal to that of the portion (28) of the first sheet of the booklet which in all the booklets is to be covered by the covering element (8).

10. A device as claimed in claim 8, characterised in that the creasing member presents at least one creasing element (11) movable perpendicular to the direction of advancement (D) of the covering elements (8) in the line (33).

11. A device as claimed in claim 10, characterised in that the creasing member also comprises a fixed creasing element (10).

12. A device as claimed in claim 10, characterised in that the movable creasing element (11) is secured to mover and guide means (16, 17, 14A, 15) for automatically moving it perpendicular to the direction of advancement (D) of the covering element in the line (33).

13. A device as claimed in claim 7, characterised in that the means for generating a particular covering element (8) for each booklet to be bound comprise at least one movable cutting member (18) arranged to remove one or more portions (P1) of the covering element; said portions being situated along at least one of the edges (8B) of the covering element, parallel to the creasing lines (L1-L4).

14. A device as claimed in claim 13, characterised in that the cutting member (18) comprises means (19, 20, 21, 15A, 16, 17) for moving it and guiding it automatically perpendicular to the direction (D) in which the covering elements (8) advance along the line (33).

15. A device as claimed in one of the preceding claims, characterised in that the binding line (33) comprises a feed station (7) for the covering elements (8), a creasing station (9) and a trimming station (13) for each of said covering elements (8), a station (22) for feeding the booklet (5) to be bound onto the previously crease-lined and/or trimmed covering element, and/or a station (23) for stapling together the booklet and a portion (21B) of the covering element, and/or a gluing station (25) arranged to spread an adhesive substance onto those portions (21A-C) of the covering element which are to be associated with each other and/or with the edge (34) of the booklet and with the portions (28) of the first and last sheet of the booklet, and/or onto said edge (34) and portions of the booklet, and/or a station (27) for rotating those parts (21A, B, C) of the covering element (8) on which an adhesive substance has been previously spread to make them adhere to each other and/or to the edge (34) of the booklet and to its upper portion (28), and/or a station (30) for pressing at least the covering element (8) and that part of the booklet wrapped by said element.

16. A device as claimed in claim 15, characterised in that the feed station (7) for the covering elements (8), the creasing station (9), the trimming station (13), the booklet feed station (22), the stapling station (23), the gluing station (25), the cover feed station (26), the rotating station (27) and the pressing station (30) are in series with each other.

17. A device as claimed in claim 15, characterised in that the gluing station (25) comprises two separate adhesive substance spreading members (25A, B) which lie opposite each other so as to be able to spread said substance on both faces of the covering element.

18. A device as claimed in claim 1, characterised in that the covering element is made of a material which can be folded and which once folded at least partly maintains the fold.

19. A device as claimed in claim 1, characterised by comprising guide and/or mover members arranged to automatically fold the covering element (8) along the weakening lines (L1-L4) and to make said folded parts adhere to the booklet.

20. A device as claimed in one of the preceding claims, characterised in that the movable creasing element (65B) and the movable cutting element (66) comprise common mover, guide and support means, so as to be simultaneously moved perpendicular to the direction (Z) of advancement of the covering elements (62), while always maintaining the same distance between them.

21. A device as claimed in claim 7, characterised in that the binding line comprises means (40) for assembling the booklets to be bound, adhesive-binding means (42) for the booklets, and mover means (41) for transferring the booklets (59) one at a time from said assembler means to the adhesive-binding means, said mover means transferring the booklets to the adhesive-binding means non-synchronously with respect to the assembler means.

22. A device as claimed in claim 7, characterised in that the binding line comprises means (40) for assembling the booklets to be bound, adhesive-binding means (42) for the booklets and mover means (41) for transferring the booklets from said assembler means (40) to said adhesive-binding means (42), in which said mover means (41) comprise means (49) for measuring the thickness of each booklet transferred.

23. A device as claimed in claim 22, characterised in that the mover means comprise a movable gripping member (46) for the booklets (59), for said gripping member there being provided automatic mover members (45, 48, 50, 53) and guide members (54) arranged to enable the gripping member to undergo vertical and horizontal movements between an exit station (40A) of said assembler means (40) and an entry station (A) of said adhesive-binding means (42).

24. A device as claimed in one of the preceding claims, characterised in that the exit station (40A) of the assembler means (40), the entry station (A) of the adhesive-binding means (42) and the means (41) for moving the booklets between said two stations are in series with each other and disposed along a rectilinear path, with the mover means being provided between said two stations.

25. A device as claimed in one of the preceding claims, characterised in that the assembler means (40), the adhesive-binding means (42) and the mover means (41) are distinct and are separate from each other.

26. A device as claimed in one of the preceding claims, characterised in that the binding line comprises means (40) for assembling the booklets to be bound, adhesive-binding means (42) for said booklets, means (41) for transferring the booklets from said assembler means to said adhesive-binding means, means (49) for measuring the thickness of each booklet to be bound, and means (60) for generating, for each booklet, on the basis of the relative measured thickness, a covering element (75) of suitable dimensions, in which all said means are connected to and controlled by a common control unit.

27. A device as claimed in one of the preceding claims, characterised by comprising guide members (78A, B) for the movement of the covering elements (8, 75) generated for each booklet on the basis of the measured thickness of the booklet, said guide members comprising at least one guide element (78B) movable in such a manner as to be able to adapt to the different dimensions of said covering elements, for said movable guide element there being provided automatic mover means (79), controlled in relation to said measured thickness.
